(19) United States
(12) Patent Application Publication
(10) Pub. No.: US 2024/0095214 A1
(43) Pub. Date: Mar. 21, 2024

(54) PROCESS & SYSTEM FOR MANAGING METADATA IN A HYPERGRAPH

(71) Applicant: INFOSYS LIMITED, Bangalore (IN)

(72) Inventors: Ramaswami MOHANDOSS, Chennai (IN); Rajan PADMANABHAN, Plano, TX (US); Ashwin DESHPANDE, Pune (IN); Matta Venkata DINESH, Issaquah, WA (US); Nisha Kottopadath PAYYAKKIL, Thiruvananthapuram (IN); Sreepriya MOHANAN, Thiruvananthapuram (IN)

(21) Appl. No.: 17/946,262

(22) Filed: Sep. 16, 2022

(51) Int. Cl. G06F 16/16

(52) U.S. Cl. CPC G06F 16/164

(57) ABSTRACT

Provided is a process and system to manage and organize metadata in a hypergraph that enables integrating the various aspects of the knowledge life cycle into a notion registry that is implemented as a combination of a hypergraph and a search engine. The present disclosure provides retrieving metadata from one or more data sources, using a first AI assisted component; and identifying and mapping a metadata available in a notion registry, closest to the retrieved metadata. An update needed in the notion registry based on the closest identified metadata is selected and update is done in the notion registry. An appropriate action, a platform for implementing the action, and a stakeholder for performing the action based on the update in the notion registry is found out using a second AI assisted component; and the action is implemented on the platform.

### FIELD

The present disclosure relates to process and system for managing metadata in a hypergraph. More precisely it relates to organizing metadata in a unified data structure.

### BACKGROUND

Knowledge workers closer to business or business facing groups continuously conceive newer notions relevant to their domain. They collaborate with their technical counterparts such as data engineers, data scientists, to materialize those notions into data elements and transform them to information assets through data pipelines and AI processes. These information assets act as the foundation for deriving knowledge allowing the business facing groups to form newer notions. This is the knowledge life cycle prevalent in any enterprise.

### SUMMARY

Provided is a process for managing metadata in a hypergraph which includes retrieving metadata from one or more data sources using a first AI assisted component. It identifies and maps a metadata available in a notion registry, closest to the retrieved metadata, identifies an update needed in the notion registry based on the closest identified metadata, and performing the identified update in the notion registry. It further includes identifying an appropriate action, an appropriate workflow to be invoked in the internal or external system, a platform for implementing the identified action, and a stakeholder for performing the identified action based on the update in the notion registry, using a second AI assisted component; and performing the identified action by invoking the appropriate workflow on the internal or external system based on one or more approvals.

Provided is a system having processor and memory instructions for managing metadata in a hypergraph which includes retrieving metadata from one or more data sources using a first AI assisted component. It identifies and maps a metadata available in a notion registry, closest to the retrieved metadata, identifies an update needed in the notion registry based on the closest identified metadata, and performing the identified update in the notion registry. It further includes identifying an appropriate action, an appropriate workflow to be invoked in the internal or external system, a platform for implementing the identified action, and a stakeholder for performing the identified action based on the update in the notion registry, using a second AI assisted component; and performing the identified action by invoking the appropriate workflow on the internal or external system based on one or more approvals.

Provided is a system having processor and memory instructions for managing metadata in a hypergraph which includes retrieving metadata from one or more data sources using a first AI assisted component. It identifies and maps a metadata available in a notion registry, closest to the retrieved metadata, identifies an update needed in the notion registry based on the closest identified metadata, and performing the identified update in the notion registry. It further includes identifying an appropriate action, an appropriate workflow to be invoked in the internal or external system, a platform for implementing the identified action, and a stakeholder for performing the identified action based on the update in the notion registry, using a second AI assisted component; and performing the identified action by invoking the appropriate workflow on the internal or external system based on one or more approvals.

Provided is a non-transitory computer readable medium with instructions stored thereon that, when executed by a processor, cause the processor to perform operations comprising managing metadata in a hypergraph which includes retrieving metadata from one or more data sources using a first AI assisted component. It identifies and maps a metadata available in a notion registry, closest to the retrieved metadata, identifies an update needed in the notion registry based on the closest identified metadata, and performing the identified update in the notion registry. It further includes identifying an appropriate action, an appropriate workflow to be invoked in the internal or external system, a platform for implementing the identified action, and a stakeholder for performing the identified action based on the update in the notion registry, using a second AI assisted component; and performing the identified action by invoking the appropriate workflow on the internal or external system based on one or more approvals.

### BRIEF DESCRIPTION OF DRAWINGS

FIG. 1 relates to a general-purpose computing environment to implement an embodiment of the present disclosure;

FIG. 2 relates to a flowchart for an embodiment of the process as described in the present disclosure;

FIG. 3 relates to a process of the registry builder;

FIG. 4 relates to the steps of the auto engineering wizard; and

FIG. 5 relates to a system for implementing as embodiment of the present disclosure.

### DETAILED DESCRIPTION

An embodiment of the present disclosure relates to organizing notions, complex technical and business metadata along with the supporting annotations in a unified data structure. With the help of unified data structure, a company can merge its many fragmented metadata across sources into one, single central view.

For the purpose of this patent application, notion maybe described as an entity, any attribute of an entity relevant to a business, or a metadata. Notion may include data such as entity, attribute; facts such as KPI or metric derived from the data such as total sales, profit percentage; features including inference made about an entity such as conversion rate of a sales person; and ‘outcome of a model’ which may be a prediction for the future, regarding sales etc. For instance, in a corporate environment, employee, employee number, employee location, skill, employee compensation, employee satisfaction, customer, account etc. can be considered as notion.

In one embodiment, a notion registry may be a combination of a hypergraph and a search engine related to a specific platform environment. While a hypergraph maybe an ideal construct to hold relationships among notions and metadata, a search engine maybe an ideal construct to hold alternate definitions of notions and other metadata in the form of annotations. In one embodiment, the search engine maybe optional. In an embodiment, a combination of a hypergraph and a search engine may be used to implement a unified data structure. In another embodiment, hypergraph may be used to implement unified data structure. The unified data structure may help organize notions, complex technical and business metadata along with the supporting annotations.

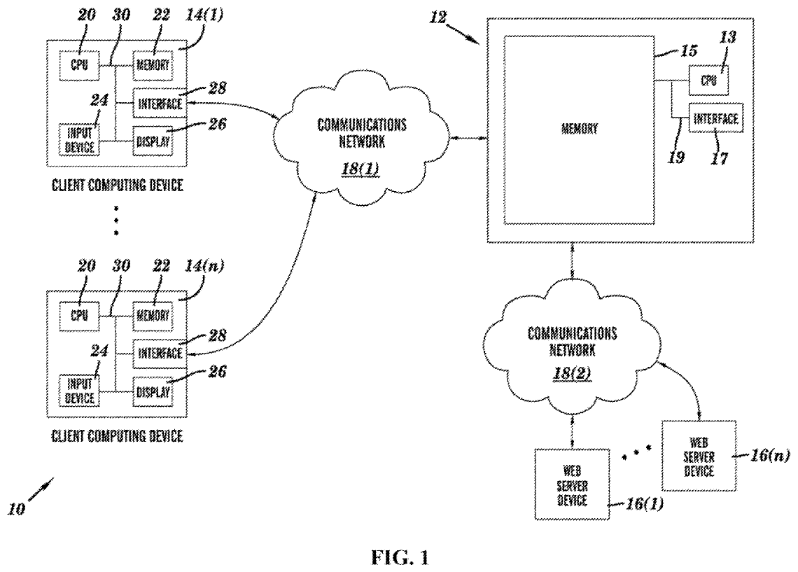

An exemplary environment 10 with a metadata organizing system 12 configured to extract and process information, is illustrated in FIG. 1, although this technology can be implemented on other types of devices, such as one of the web server devices 16(1)-16(n), or any other server computing apparatus configured to receive and process hypertext transfer protocol (HTTP) requests, by way of example only. The exemplary environment 10 includes an metadata organizing system 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide knowledge processing system.

Referring more specifically to FIG. 1, the metadata organizing system 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the metadata organizing system 12 executes a program of stored instructions for one or more aspects of the present disclosure as described and illustrated by way of the embodiments herein, although the processor could execute other numbers and types of programmed instructions.

The memory 15 in the metadata organizing system 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the metadata organizing system 12.

The interface system 17 in the metadata organizing system 12 is used to operatively couple and communicate between the metadata organizing system 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the metadata organizing system 12 via one or more communication networks 18(1). Although multiple client devices 14(1)-14(n) are shown, other numbers and types of user computing systems could be used. In one example, the client devices 14(1)-14(n) comprise smart phones, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the metadata organizing system 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the web content optimization computing apparatus 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the embodiments herein, although the processor could execute other numbers and types of programmed instructions.

The memory in each of the web server devices 16(1)-16(n) stores these programmed instructions for one or more aspects of the present invention as described and illustrated by way of the embodiments described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the metadata organizing system 12, and the client devices 14(1)-14(n) via the communication networks 18(1) and 18(2), although other types and numbers of communication networks with other types and numbers of connections and configurations can be used.

Although embodiments of the metadata organizing system 12, the client devices 14(1)-14(n), and the web server devices 16(1)-16(n), are described and illustrated herein, each of the client devices 14(1)-14(n), the knowledge processing system 12, and the web server devices 16(1)-16(n), can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

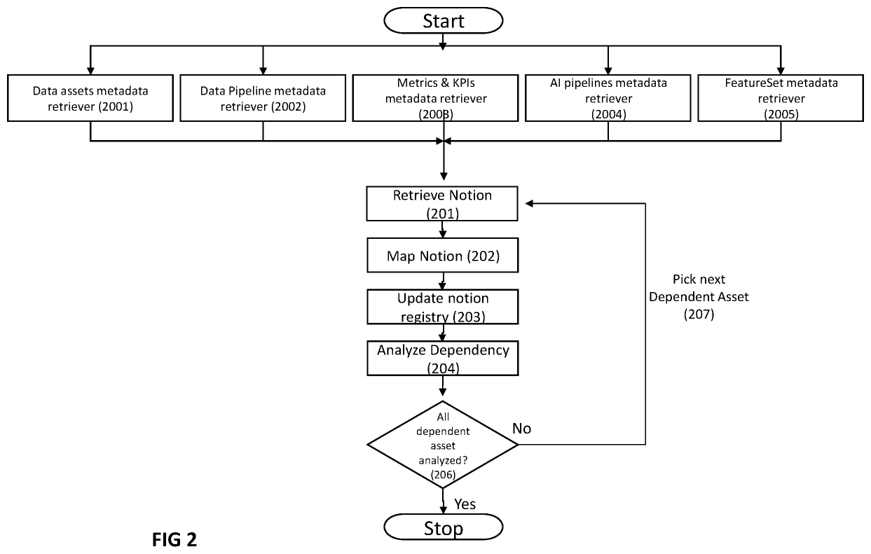

An embodiment of the process to implement the present disclosure will now be explained along with the description of FIG. 2. In an embodiment, for a platform environment, the metadata or notions may be retrieved from asset source or data source related to the platform environment (201), for instance the present disclosure maybe implemented in a corporate environment, medical, travel etc. Platform environment could be development, test or production.

In an embodiment, it may be done using a data asset metadata retriever (2001) for the platform environment. This component maybe responsible for retrieving metadata such as table or column description of data assets from databases. This component may be implemented through system tables or via API.

In one embodiment, the metadata may be retrieved from data pipeline metadata retriever (2002) for the environment. This component may be configured for retrieving metadata such as code description, comments of data processing code assets from GIT or other code repositories.

In one embodiment, the metadata may be retrieved from Metrics & KPIs metadata retriever (2003) for the environment. This component may be configured for retrieving KPIs and metrics including facts and dimensions description, from data products and other visualization tools via API.

In one embodiment, the metadata maybe retrieved from AI pipelines metadata retriever (2004) for the environment. This component maybe configured for retrieving metadata such as code description, and comments of AI assets from GIT or other code repositories.

In one embodiment, the metadata maybe retrieved from feature set metadata retriever (2005) for the environment. This component maybe configured for retrieving metadata such as feature or feature-set description of feature assets from feature store and other repositories.

For instance, in a github repository each program maybe an asset, and relevant comments in the program may be metadata that maybe retrieved by the metadata retriever.

In one embodiment, the metadata retrievers as explained above (2001-2005) will analyze each of the assets in the data source, and segregate the relevant metadata. This metadata could include comments, annotations and descriptions that are available for the underlying asset.

In one embodiment, AI and ML techniques may be adopted to segregate descriptive metadata details about the underlying assets such as data assets, data pipeline code assets, AI code assets, metrics and KPI assets or feature assets. Descriptive metadata could be nouns, adjectives, verbs or combinations of those extracted from the metadata extracted by 2001-2005.

Once the metadata is retrieved, the notion registry for that platform environment maybe scanned to identify any existing notion most relevant to the retrieved metadata or notion (202). In one embodiment, the most relevant metadata or notion available in the notion registry may be identified by checking synonyms of the metadata, or related acronyms or abbreviations or any entity related to the extracted metadata may be identified as relevant. The identified relevant notion maybe mapped to the asset (202). The notion registry may persist the details of the notion and its relationships with other assets in a hypergraph. Specific details around these entities i.e. data, fact, feature and model maybe captured in sub registries that maybe implemented as part of the hypergraph.

The relevant notion identified in the notion registry and the retrieved notion may be analyzed to check and decide the update needed in the notion registry; and perform the appropriate update (203). The notion registry may be needed to be edited or some addition and deletions to be done. In one embodiment it may also be needed to decide the stakeholder who can approve the change to be done. In one embodiment, it may be one of business user/SME; data engineer, or a data scientist. In another embodiment there may be further stakeholders as appropriate for the updates needed in the notion registry.

In one embodiment, a business user or the SME forms the notion in a specific jurisdiction or environment. The SME may capture the attributes to be collected along with the legal requirements around that notion and shares it with a data engineering team.

In one embodiment, a data engineer may translate the notion into a set of data elements via data model. The data engineer may realize the model in a data platform, along with provisioning the appropriate infrastructure. Provisioning may involve applying the right governance policies. The data engineer may also perform the needed testing of the data pipeline.

In one embodiment, a data scientist may perform the training of the AI models. The data scientist may share the role of the data engineer, along with the testing or the training.

In one embodiment, the dependent component assets of the present asset may also be identified in the asset source (204). This may help discover impacted assets when an asset is either inserted or updated. The dependent assets may mean the assets that can be manipulated by the main asset. For instance, in a data pipeline, the dependent assets maybe data assets.

In one embodiment, the above process is performed for each dependent asset (207). The process may be repeated so that all dependent assets for all assets are covered. This may enable update the notion registry to a great extent, and the users may be provided with updated data or assets as per their requirements.

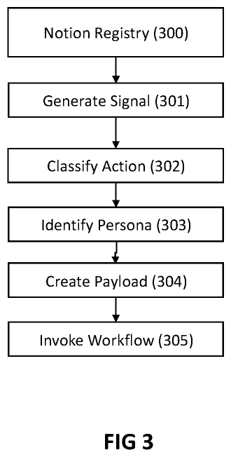

An embodiment of the process describing the notion registry update will now be described along with the description of FIG. 3.

In an embodiment, once the metadata is extracted, and a relevant update to the notion registry (300) is identified, the notion registry may generate a signal or a notification using an AI/ML component. The AI/ML component may package the signal using the preexisting metadata that needs update and the extracted metadate (301). In an embodiment, packaging may include details of the asset that got updated in the registry along with the related notions.

In an embodiment, the right update process may be identified by an AI/ML component configured to analyse the packaged signal (302). Accordingly, the right workflow needed for the identified update maybe classified, from a set of workflows. For instance, to perform a review of the impacted asset.

In an embodiment, the right stakeholder may be identified by an engineering component. The identified stakeholder may receive the packed signal in form of a proposal to approve or deny the identified action (303). In an embodiment, a proposal packager may package the final intelligence that can be delivered to the stakeholder through an engineering component.

In one embodiment, once the proposal package is ready with the approvals, the appropriate components corresponding to the identified update may be triggered to perform the update (305) and the related workflow in the internal system or an external system. Internal system maybe one of the components like the notion registry as disclosed earlier. External system maybe an already existing system component in the platform environment, or a third party component. The components performing the update maybe one or more of the components described earlier. Alternatively further components and appropriate updates may be identified and configured by the users as per the platform environment. Platform environment could be development, test or production.

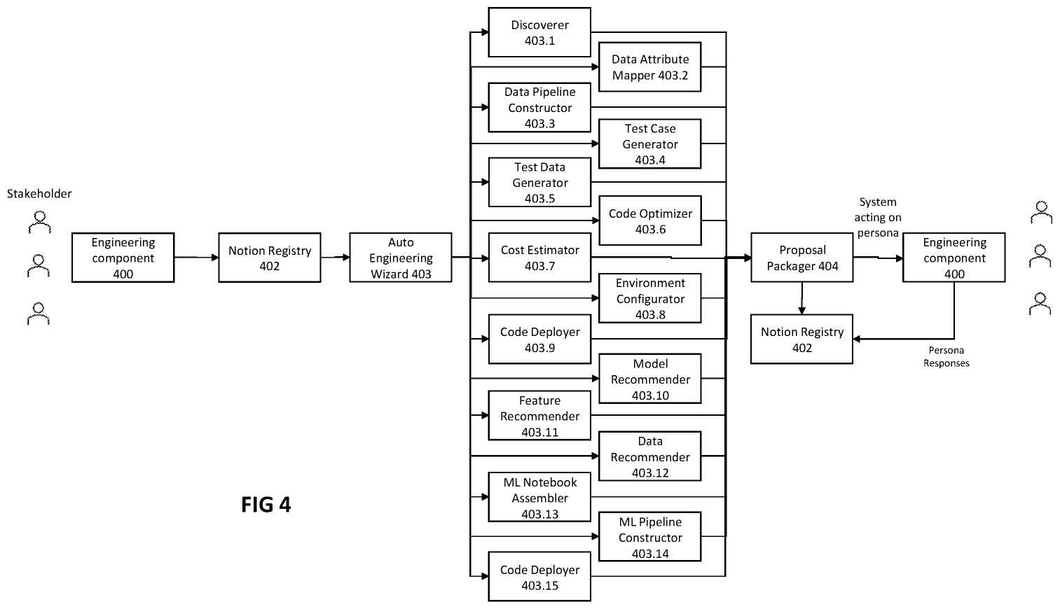

An embodiment of the system to implement the process as disclosed herein will now be explained along with the description of FIG. 4.

In an embodiment the stakeholders i.e. data scientists, business users, or data engineers access an engineering component. The engineering component may be an intelligent user interface based component for all stakeholders, configured to help create, discover and manage notions along with its various related notions and manifestations. It may be also configured to create, edit, refine and approve notions to the registry, which may enable updating the registry as per the process defined earlier.

In one embodiment, the appropriate action is identified to take care of the needed update in the notion registry. In one embodiment, the action and the enabling component can be one or more of:

Discoverer (403.1)—may be configured to search for notions along with its various manifestations, discover similar notions and propose new notions from the registry.

Data Attribute Mapper (403.2)—an AUML based component that may be configured to help identify the closest entity in the Data Registry that matches a notion.

Data Pipeline Constructor (403.3)—an AUML based component that may be configured to construct the data pipeline component from scratch based on the details extracted by the Data Attribute Mapper.

Test Case Generator (403.4)—an AUML based component that may be configured to help identify relevant test cases for a data pipeline component.

Test Data Generator (403.5)—an AUML based component that may be configured to create relevant test data for a data pipeline component picking details form the various registries.

Code Optimizer (403.6)—an AUML based component that may be configured to help programmatically optimize a data pipeline component.

Cost Estimator (403.7)—Core component that may be configured for estimating the cost involved in provisioning and implementing the tech stack as identified by a platform environment configurator (403.8).

Platform Environment Configurator (403.8)—a platform agnostic component that may be configured to translate the governance details in the notion registry into implementable policies such as encryption, access control, masking and others.

sizing of the technology components relevant for the data pipeline code asset or AI code asset component. In an embodiment, Data Pipeline metadata retriever (2002) and AI pipelines metadata retriever (2004) may work out of these assets.

Code Deployer (403.9)—a core component that may be configured to implement the details received through the environment configurator along with the assembled code base.

Model Recommender (403.10)—an AUML based component that may be configured to identify the ai assets that are relevant to the notion.

Feature Recommender (403.11)—an AUML based component that may be configured to identify relevant features that can be leveraged for a particular AUML model.

Data Recommender (403.12)—an AUML based component that may be configured to identify relevant data sets that can be leveraged to build model features.

ML Notebook Assembler (403.13)—an AUML based component that may be configured to construct an experimentation notebook with the relevant packages assembled based on the context for the stakeholders as described earlier, to begin their experimentation.

ML Pipeline Constructor (403.14)—an AUML based component that may be configured to construct an ML pipeline component, including relevant explainer and measurement code, from scratch based on the details extracted by the model recommender (403.10).

In one embodiment, the above components and their associated processes maybe identified for each of the metadata extracted from the data sources.

In one embodiment, the above components and the updating components (403.1-403.14), as defined earlier, may be organized and orchestrated together using an auto engineering wizard (403). The auto engineering wizard may take inputs from the engineering component and notion registry and identify the updating components using a signal generated by the notion registry.

In one embodiment, as defined above the proposal packager (404) forwards the signal received from the notion registry and the identified stakeholder detail as a proposal package. A proposal package may be any data structure or a data packet comprising information including the metadata, the update action to be performed, the stakeholder identified, and other relevant information.

The action to be performed details can be sent to the engineering component (400) to update the notion registry (402).

In an embodiment this data flow and process is performed for all the metadata extracted from the data source. This enables keep the notion registry updated.

In an embodiment the present disclosure may enable bringing in relevant notions, technical metadata of data assets, pipelines, data pipelines, annotations and other data sources into a notion registry that maybe implemented on any unified data structure for instance, hypergraph and a search engine.

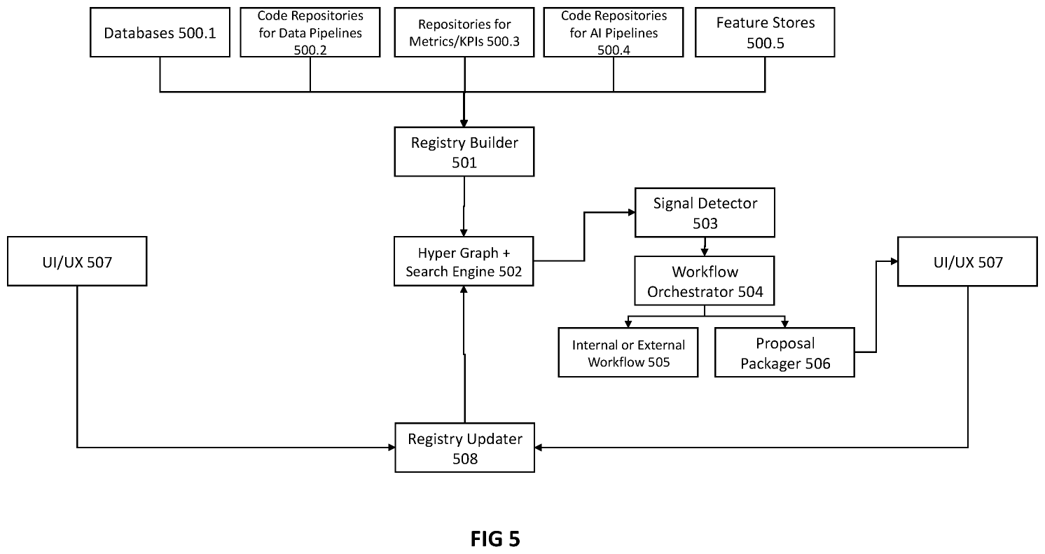

An embodiment of the architecture to implement the present disclosure will now be explained along with the description of FIG. 5.

In one embodiment there may be one or more metadata retrievers configured appropriately to get input data assets from databases (500.1); Code Repositories for Data Pipelines (500.2); Repositories for Metrics/KPIs (500.3); Code Repositories for AI Pipelines (500.4) or Feature Stores (500.5). In one embodiment, there may be further metadata retriever configured to get data assets from other alternative sources

In one embodiment, the metadata may be transferred to a notion registry builder (501). The registry builder may have components configured to find the appropriate notion registry update and workflow as explained in the above paragraphs. In one embodiment, the notion registry may have one or processor configured to perform the process for notion registry as explained earlier.

In one embodiment, the notion registry maybe implemented in the form of a hypergraph and a search engine (502). The hypergraph maybe used to implement a unified data structure, as explained in the earlier paragraphs.

In one embodiment a signal detector (503) may be configured to detect the workflow and notion registry update, and generate a signal or another form of data transfer or notifications. The notion and the notification details maybe packaged as a signal and sent to a workflow orchestrator (504). The workflow orchestrator may be configured to receive the signal from the signal generator and interpret it to invoke the appropriate workflow. The components of the workflow orchestrator maybe invoked appropriately as per the workflow identified. The components to be invoked maybe as per explained earlier, along with the description of FIG. 4.

In one embodiment, the workflow maybe invoked in an internal system or an external system. An internal system maybe one of the components like the notion registry as explained in this disclosure. An external system maybe an already existing or a third party system component.

The identified workflow, the internal or external system and the signal may be combined in a single data file, or a proposal by a proposal packager (506). The proposal packager may have access to multiple repositories and combine the data as required.

In one embodiment the proposal packager may send the data to a User Interface component (507) of an appropriate stakeholder who may implement or approve the workflow. The stakeholder may be identified based on the identified workflow or the internal or external system. The stakeholder may be decided by any other appropriate process as well, as needed by the users.

In one embodiment, the actions performed through the user interface (507) may trigger the registry updater (508) and the required workflow maybe performed.

In an embodiment, the components as described above maybe arranged over a network with a distributed architecture. These components maybe installed in various client machines connected through any communication interface.

In one embodiment, the components maybe installed and implemented on a cloud architecture. The implementation may be configured by the user as per the platform environment and intranet or internet setup. The access rules and data transfer for each component maybe defined and can be configurable as needed.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A process for managing metadata in a hypergraph, comprising:
retrieving metadata from one or more data sources, using a first AI assisted component;
identifying and mapping a metadata, available in a notion registry, closest to the retrieved metadata;
identifying an update needed in the notion registry based on the closest identified metadata, and performing the identified update in the notion registry;
identifying an appropriate action, an appropriate workflow to be invoked in a system, and a stakeholder for performing the identified action based on the update in the notion registry, using a second AI assisted component; and
performing the identified action by invoking the appropriate workflow on the system based on one or more approvals.

2. The process as claimed in claim 1, wherein the first AI assisted component is configured to exclude portions of the metadata.

3. The process as claimed in claim 1, wherein the identifying a metadata closest to the retrieved metadata comprises identifying synonyms or acronyms related to the retrieved metadata in the notion registry.

4. The process as claimed in claim 1, wherein the identified update comprises creating a new notion in the notion registry, or modifying an existing notion in the notion registry.

5. The process as claimed in claim 1, wherein the identifying the appropriate action further comprises selecting from one or more of pre-decided actions, by the second AI assisted component.

6. A system, for managing metadata in a hypergraph, comprising a processor and a memory comprising instructions executable by the processor to cause the system to:
retrieve metadata from one or more data sources, using a first AI assisted component;
identify and map a metadata available in a notion registry, closest to the retrieved metadata;
identify an update needed in the notion registry based on the closest identified metadata, and perform the identified update in the notion registry;
identify an appropriate action, an appropriate workflow to be invoked in a system, and a stakeholder for performing the identified action based on the update in the notion registry, using a second AI assisted component; and
perform the identified action by invoking the appropriate workflow on the system based on one or more approvals.

7. The system as claimed in claim 6, wherein the first AI assisted component is configured to exclude portions of the metadata.

8. The system as claimed in claim 6, wherein the identifying a metadata closest to the retrieved metadata comprises identifying synonyms or acronyms related to the retrieved metadata in the notion registry.

9. The system as claimed in claim 6, wherein the identified update further comprises creating a new notion in the notion registry, or modifying an existing notion in the notion registry.

10. The system as claimed in claim 6, wherein the identifying the appropriate action further comprises selecting from one or more of pre-decided actions, by the second AI assisted component.

11. A non-transitory computer readable medium with instructions stored thereon that, when executed by a processor, cause the processor to perform operations comprising:
retrieving metadata from one or more data sources, using a first AI assisted component;
identifying and mapping a metadata available in a notion registry, closest to the retrieved metadata;
identifying an update needed in the notion registry based on the closest identified metadata, and performing the identified update in the notion registry;
identifying an appropriate action, an appropriate workflow to be invoked in a system, and a stakeholder for performing the identified action based on the update in the notion registry, using a second AI assisted component; and
performing the identified action by invoking the appropriate workflow on the system based on one or more approvals.

12. The non-transitory computer readable medium as claimed in claim 11, wherein the first AI assisted component is configured to exclude portions of the metadata.

13. The non-transitory computer readable medium as claimed in claim 11, wherein the identifying a metadata closest to the retrieved metadata further comprises identifying synonyms or acronyms related to the retrieved metadata in the notion registry.

14. The non-transitory computer readable medium as claimed in claim 11, wherein the identified update further comprises creating a new notion in the notion registry, or modifying an existing notion in the notion registry.

15. The non-transitory computer readable medium as claimed in claim 11, wherein identifying the appropriate action comprises selecting from one or more of pre-decided actions, by the second AI assisted component.
